(19) United States
(12) Patent Application Publication
(10) Pub. No.: US 2006/0064929 A1
(43) Pub. Date: Mar. 30, 2006

(54) Irrigation and soluble product delivery system

(76) Inventor: David M. Allen, Howell, MI (US)

Correspondence Address: HARNESS, DICKEY & PIERCE, P.L.C., P.O. BOX 828, BLOOMFIELD HILLS, MI, 48303, US

(21) Appl. No.: 10/953,698

(22) Filed: Sep. 29, 2004

(51) Int. Cl. A01G 29/00

(52) U.S. Cl. 47/48.5

(57) ABSTRACT

An article for storing water and selectively dispensing the water to an area proximate a root system. The article includes a rigid lower container that is segregated into a first quantity (n) of container portions where each of container portion is configured to separately hold a predetermined quantity of water. The article also includes a second quantity (m, where m≧(n−1)) of valves that can be positioned in an open condition, which permits fluid communication therethrough to allow the predetermined quantity of water to be drained from an associated one of the container portions, and a closed position, that inhibits fluid flow therethrough. A method for irrigating a root system is also provided.

### INTRODUCTION

The present invention generally relates to irrigators for trees, shrubs and other vegetation and more particularly to an irrigator with a plurality of water compartments that may be separately accessed to distribute water.

Immediately after re-planting, a tree is relatively susceptible to drought since a large portion of its root system is typically lost when the tree is removed from its original location. In some areas of the country, the rate at which transplanted trees are lost can run upwards of 40 to 60 percent. To reduce the rate of loss, many consumers require a landscaper who installs the trees to water the trees at a predetermined frequency (e.g., 15 gallons of water every two days). While mandatory watering of newly transplanted trees has done much to reduce the rate at which the transplanted trees are lost, several drawbacks have been noted.

One such drawback concerns the cost that is incurred through relatively frequent deliveries of water to a tree. In this regard, the use and frequent operation of specialized water delivery trucks and the manpower for operating the truck and dispensing the water is relatively expensive and this cost is ultimately passed on to the purchaser.

Another drawback concerns the rate with which the water that is dispensed is absorbed by the tree. Specifically, the roots of a newly transplanted tree cannot absorb the several gallons of water that are dispensed over a span of a few minutes and therefore, much of the water that is dispensed in this manner is wasted. Accordingly, more frequent watering intervals where less water is dispensed would be beneficial to the tree, but would even further increase costs.

### SUMMARY

In one form, the present teachings provide an article for storing water and selectively dispensing the water to an area proximate a root system. The article includes a rigid lower container that is segregated into a first quantity (n) of container portions where each of container portion is configured to separately hold a predetermined quantity of water. The article also includes a second quantity (m, where m≧(n−1)) of valves that can be positioned in an open condition, which permits fluid communication therethrough to allow the predetermined quantity of water to be drained from an associated one of the container portions, and a closed position, that inhibits fluid flow therethrough.

In another form, the present teachings provide a method for irrigating a root system that includes: placing a container that is segregated into a plurality of container portions in a location proximate a root system; filling the container such that each of the container portions has a predetermined quantity of water; dispensing water held in a first one of the container portions at a first point in time to irrigate the root system; and dispensing water held in a second one of the container portions at a second point in time that is spaced apart from the first point in time to irrigate the root system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a perspective view of an article for irrigating a root system constructed in accordance with the teachings of the present invention and in operative association with a root system;

FIG. 2 is an exploded perspective view of the article of FIG. 1;

FIG. 2A is an enlarged portion of FIG. 2 illustrating a valve in more detail;

FIG. 2B is another enlarged portion of FIG. 2 illustrating a valve as coupled to a hose;

FIG. 3 is a side view in partial section of the article of FIG. 1;

FIG. 4 is an exploded view of another article for irrigating a root system constructed in accordance with the teachings of the present invention;

FIGS. 5, 6 and 7 are perspective views of one or more of the articles of FIG. 4 in operative association with one or more root systems;

FIG. 8 is a side elevation view of yet another article for irrigating a root system constructed in accordance with the teachings of the present invention, the article being located on a sloped surface; and

FIG. 9 is a side elevation view of still another article for irrigating a root system constructed in accordance with the teachings of the present invention.

### DETAILED DESCRIPTION OF THE VARIOUS EMBODIMENTS

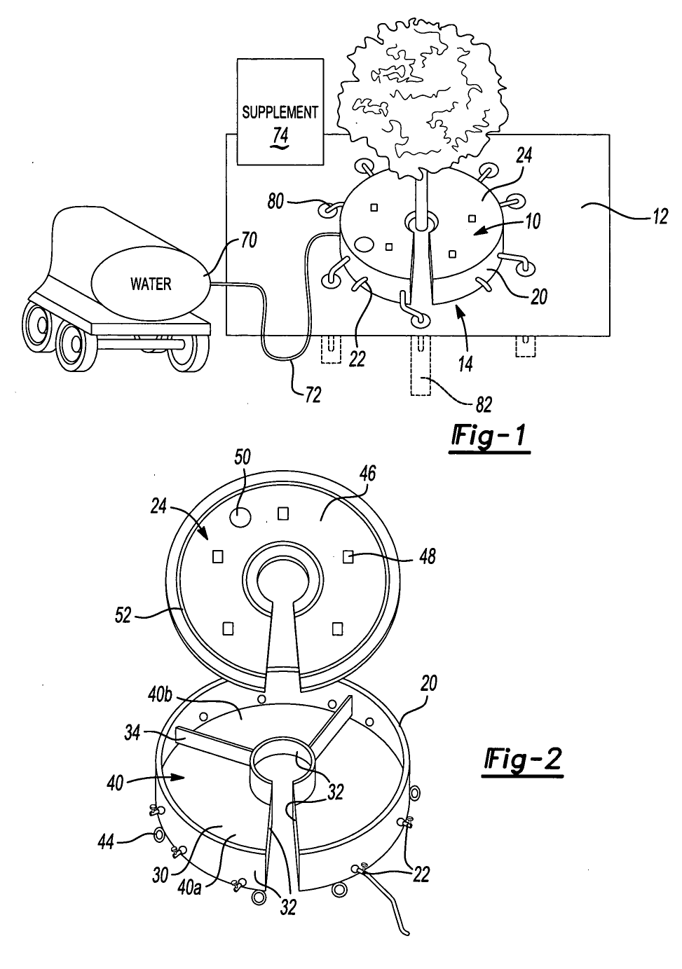

With reference to FIG. 1 of the drawings, an article constructed in accordance with the teachings of the present invention is generally indicated by reference numeral 10. The article 10 is configured to be capable of storing water and selectively dispensing the water to an area 12 proximate a root system 14. The article 10 can comprise a lower container 20, a plurality of valves 22 and a lid 24.

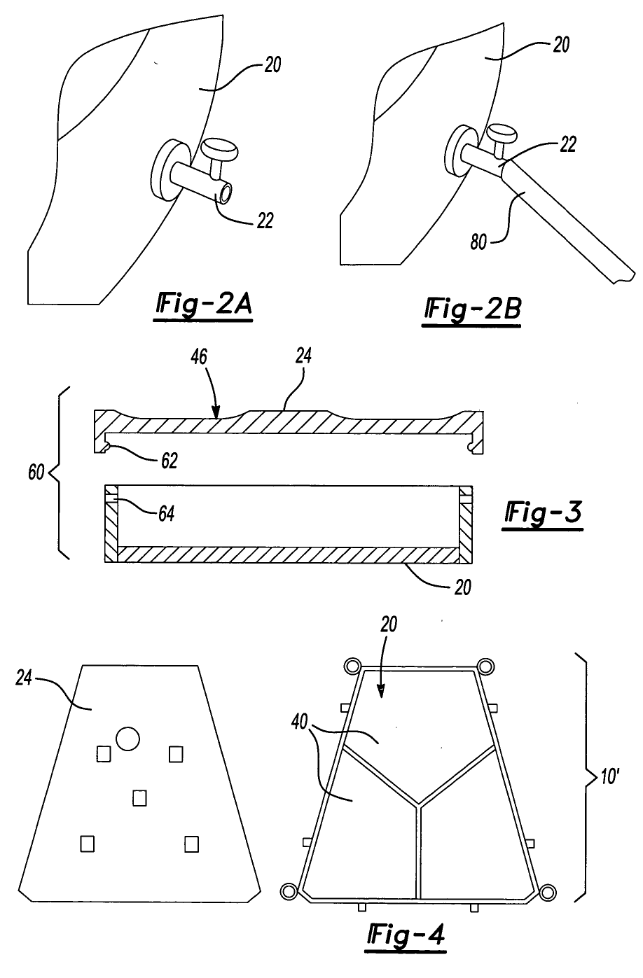

With reference to FIG. 2, the lower container 20 can be unitarily formed from a suitable material, such as a UV stabilized polypropylene material, and may be colored in any desired manner. The lower container 20 can include a bottom wall 30, at least one exterior wall 32 and at least one interior wall 34 that can cooperate to segregate the lower container 20 into a plurality of container portions 40. Each container portion 40 is configured to hold a predetermined quantity of water in a manner that permits it to be segregated from the water from that is held in the other container portions 40. If desired, the bottom wall 30 can be pitched or sloped toward the valves 22.

In the example provided, the lower container 20 is shaped in the form of an annular segment with an inside diameter that is about 6 inches to about 12 inches in diameter. While the lower container 20 can be formed of a rigid material, it can be appreciated that construction in this manner provides the lower container 20 with a degree of flexibility that permits the ends of the lower container 20 to be moved relative to one another to “open” the lower container 20 so that it may be arranged about the trunk of a tree.

The exterior walls 32 and interior walls 34 are configured to provide each of the container portions 40 with a capacity of about 1 gallon to about 20 gallons of water and more preferably a capacity of about 2 gallons to about 8 gallons. In the particular example provided, the exterior walls 32 extend above the bottom wall 30 by a first dimension that is relatively larger than a dimension by which the interior walls 34 extend above the bottom wall 30. Accordingly, water may be dispensed into one of the container portions 40 and when that container portion 40 is filled with its predetermined quantity of water, the water will flow over the adjacent interior walls 34 and begin to fill adjacent container portions 40. With the aforementioned configuration of the exterior walls 32 and interior walls 34, it can be appreciated that the overall capacity of the lower container 20 can exceed the aggregate capacities of the plurality of container portions 40.

The lower container 20 can include one or more anchor attachments 44 that may be attached to the bottom wall 30 or an exterior wall 32, for example, that permits the lower container 20 to be staked or otherwise fastened to the ground in a desired area. The anchor attachments 44 can be a ring or tubular element that may be welded or adhesively coupled to the lower container, for example. The anchor attachments 44 can be employed to securely fasten the lower container 20 in a desired area and can serve as a theft deterrent.

With brief additional reference to FIG. 2A, each valve 22 is coupled to an associated container portion 40 and may be operated in an open condition, which permits water from the associated container portion 40 to flow through the valve 22, and a closed condition, which inhibits the water in the associated container portion 40 from flowing there through. In the particular example provided, a plurality of valves 22 are associated with each container portion 40 wherein the valves 22 are coupled to the exterior wall 32 of the lower container 20. It can be appreciated, however, that a smaller quantity of valves 22 may be employed, such as one valve 22 per container portion.

Minimally, the quantity (m) of valves 22 that are employed is one less than the quantity (n) of container portions 40, i.e., m≧n−1. In this minimum configuration, a first one of the container portions 40 is configured to drain water when water is present therein (i.e., the first container portion is not valved) and the valves 22 are employed to control the dispensing of water from other container portions 40 to the first container portion.

Returning to FIGS. 1 and 2, the lid 24 can be formed in a shape that is complementary to that of the lower container 20 to permit the interior of the lower container 20 to be closed to reduce evaporation and/or to reduce the amount of dirt and debris that are introduced into the lower container 20. With additional reference to FIG. 3, the lid 24 can include a recess 46 and can be contoured so that water that is deposited onto the lid 24 can be directed into the recess 46. One or more drain apertures 48 can be located in the recess 46 and formed through the lid 24 to permit water in the recess 46 to drain into the interior of the lower container 20. Construction in this manner permits the article 10 to capture rain and sprinkler water where it may be reserved for future use without having to manually refill the lower container 20. The lid 24 can include a single nozzle opening 50 that can be disposed within the recess 46 and which can be adapted to receive a nozzle or hose for filling the container portions 40.

Like the lower container 20, the lid 24 can be formed from a suitable material, such as a UV stabilized polypropylene material, and can be colored in any desired manner. Preferably, the lid 24 is formed with an upper exterior surface 52 that is environmentally camouflaged. As used herein, the term “environmentally camouflaged” is employed to define a surface coloration and optionally a texture that cause the lid 24 to be more readily associated with the environment in which the article 10 is located. In this regard, the exterior surface 52 may have an appearance that simulates a mound of mulch, bark or stones, for example. Alternatively, the exterior surface 52 of the lid 24 can be configured to display advertising or information (e.g., a map if the article 10 is used in a park setting). In situations where it is desirable that the advertising or information be periodically changed hardware (not shown), such as a mounting plaque or bracket, can be coupled to the lid 24.

The lower container 20 and lid 24 may include a latch 60 for selectively latching the lid 24 to the lower container 20. The latch 60 may include a first latch portion 62, such as locking tabs, that may be carried by either the lower container 20 or the lid 24 (shown as being carried by and integrally formed with the lid 24 in the example provided), and a second latch portion 64, such as a recess, that can be carried by the other one of the lower container 20 and the lid 24 (i.e., carried by and integrally formed with the lower container 20 in the example provided) and are configured to receive the first latch portion 62. Selective attachment of the lid 24 to the lower container 20 permits the interior of the lower container 20 and the valves 22 to be efficiently cleaned on a periodic basis to remove any silt, fertilizer, or dirt and debris that may tend to restrict the flow of water that is released from the article 10.

Returning back to FIGS. 1 and 2, to use the article 10, the lower container 20 and the lid 24 can be positioned proximate the root system 14, the lid 24 can be secured to the lower container 20 and the valves 22 can be maintained in the closed condition. A portable water source 70, such as a water hauling truck, can be located proximate the article 10 and a hose 72 can be employed to dispense water from the portable water source 70 to fill each of the container portions 40 with the predetermined quantity of water. Optionally, a material that may be dispensed by the article 10, such as a ground conditioner (e.g., a substance that reduces surface tension to improve wetting), a pesticide, a fungicide, or a nutrient supplement 74 (e.g., fertilizer), can be dispensed in a liquid or soluble solid form into one or more of the container portions 40 so that the material may be dispensed simultaneously with the water when the water is dispensed from the associated container portion(s) 40.

The valve or valves 22 associated with a first one 40a of the container portions 40 can be operated in the open condition to dispense the water that is held therein at a first point in time (t₁) to irrigate the root system 14. Thereafter, the valve or valves 22 associated with a next one of the container portions 40 can be operated in the open condition to dispense the water that is held therein at a next point in time (tₙ) that is spaced apart from a time at which the root system 14 was last irrigated by the article 10. As an illustrative example, a second one 40b of the container portions 40 can be operated in the open condition to dispense the water that is held therein at a second point in time (t₂) to irrigate the root system 14 where t₂ is later in time than t₁. It can be appreciated that the water from each of the container portions 40 may be emptied before it is necessary to employ the portable water source 70 to refill the article 10 with water. Accordingly, considerable savings can be realized with the article 10 through less frequent use of portable water sources 70 such as water hauling trucks. In this regard, multiple irrigation events may take place over an extended period of time without having to haul water to the site for each irrigation event. It can also be appreciated that the valves 22 may be closed so as to halt the dispensing of water from the article 10 based on weather conditions (i.e., rain is forecasted) or on the amount of water in the soil surrounding the root system 14.

It can be appreciated that in some applications, it may be beneficial to more precisely control the water that is dispensed from the article 10. In some situations, a fluid conduit 80 (FIG. 2B), such as a hose, may be coupled to one or more of the valves 22 so that water that is dispensed through the valve(s) 22 can be directed in a desired manner. Specifically, the fluid conduit 80 can be configured to distribute the water to an area of the ground that is spaced apart from the lower container 20, as is illustrated in FIG. 2, and/or can be configured to distribute the water into a vertically extending perforated conduit 82 that can be employed to water and optionally aerate the root system 14 as is illustrated in FIG. 1. Both configurations facilitate the irrigation of more mature root systems 14 that have grown relatively far away from the trunk or central stem of the tree or plant. The latter configuration, however, is particularly efficient, since the water that is dispensed is directed to the root system 14 and is not subject to run off.

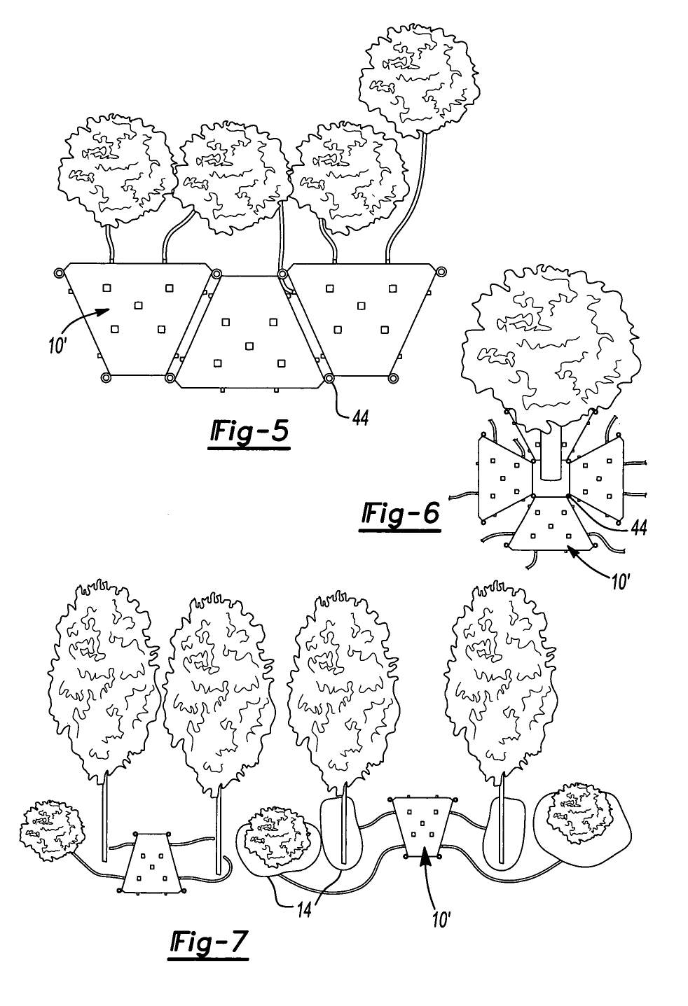

While the article 10 has been illustrated and described herein as having the shape of an annular segment that is suited for placement about a plant, such as the trunk of a tree, it can be appreciated that the invention, in its broadest aspects, may be constructed somewhat differently. As shown in FIGS. 4 through 6, the article 10′ can be shaped in the form of a quadrilateral, such as a trapezoid, that permits several of the articles 10′ to be abutted against one another to form a row or to be fitted around an object, such as a tree with a relatively large diameter trunk. Arrangement of the articles 10′ in a row facilitates the irrigation of a row of trees, shrubs, etc., especially in situations where the plants in the row are positioned relatively close to one another. Placement of the articles 10′ in close proximity to one another permits one or more of the anchor attachments 44 to be used in combination with one another. In this regard, an adjacent pair of anchor attachments 44 may be overlaid onto one another and a single stake or other attachment means may be driven or placed through the overlaid pair of anchor attachments 44.

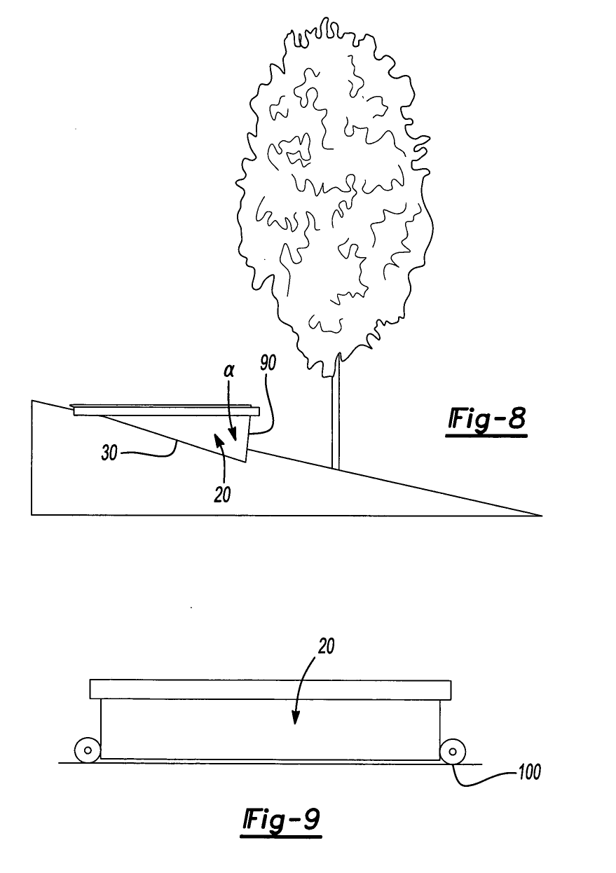

It can be further appreciated that while the articles 10 and 10′ have been illustrated and described as being associated with a single root system 14, the invention in its broadest aspects need not be so limited. With reference to FIG. 7, a single article 10′ can be employed to distribute water to several root systems 14, particularly where fluid conduit(s) 80, such as a hose(s), are coupled to one or more of the valves 22 so that water that is dispensed through the valve(s) 22 can be directed in a desired manner. Moreover, the bottom wall 30 of the lower container 20 may be sloped relative to an end wall 90 at a predetermined angle as is shown in FIG. 8 to accommodate hillside installations. With this configuration, the included angle (a) between the end wall 90 and the bottom wall 30 is less than about 80°. Furthermore, a set of wheels 100 may be attached (permanently or removably) to the article that permits a user to more readily locate or reposition the article relative to a given tree or shrub as is shown in FIG. 9.

While the invention has been described in the specification and illustrated in the drawings with reference to various embodiments, it will be understood by those skilled in the art that various changes may be made and equivalents may be substituted for elements thereof without departing from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise, above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. An article for storing water and selectively dispensing the water to an area proximate a root system, the article comprising:
a rigid lower container segregated into a first quantity (n) of container portions, each container portion being configured to separately hold a predetermined quantity of water;
a second quantity (m) of valves, the valves being operable in an open condition, which permits fluid communication therethrough to allow the predetermined quantity of water to be drained from an associated one of the container portions, and a closed position, that inhibits fluid flow therethrough;
wherein m≧(n−1).

2. The article of claim 1, further comprising a lid that is removably coupled to the lower container.

3. The article of claim 2, wherein the lower container includes at least one exterior wall, a bottom wall and at least one inner wall that cooperate to form the container portions, the at least one inner wall extending above the bottom wall by a dimension that is smaller than a dimension by which the at least one exterior wall extends above the bottom wall.

4. The article of claim 3, wherein the lid includes a single nozzle opening that is adapted to receive a nozzle or hose for filling the container portions.

5. The article of claim 2, wherein the lid includes a recessed portion and wherein at least one drain aperture is located in the recess and is formed through the lid, the recess being configured to direct water on the lid into the at least one drain aperture.

6. The article of claim 2, wherein one of the lid and the lower container includes a first latch portion for engaging a second latch portion that is coupled to the other one of the lid and the lower container.

7. The article of claim 6, wherein the first latch portion includes a plurality of locking tabs and wherein the second latch portion includes a plurality of recesses for receiving the locking tabs.

8. The article of claim 2, wherein the lid has an environmentally camouflaged upper surface.

9. The article of claim 1, further comprising a plurality of anchor attachments that are coupled to and disposed about the lower container.

10. The article of claim 1, further comprising a hose coupled to one of the valves, the hose being configured to direct water to an area that is spaced apart from the one of the valves when the one of the valves is opened and water is flowing therethrough.

11. The article of claim 10, further comprising a hollow porous cylinder that is adapted to be at least partially buried in the ground proximate the root system and wherein an end of the hose opposite the one of the valves is positioned to dispense water into the hollow porous cylinder.

12. The article of claim 1, wherein the lower container is shaped in the form of an annular segment.

13. The article of claim 1, wherein the lower container has a bottom wall and an end wall and wherein an included angle between the end wall and the bottom wall is less than about 80°.

14. A method for irrigating a root system comprising:
placing a container that is segregated into a plurality of container portions in a location proximate a root system;
filling the container such that each of the container portions has a predetermined quantity of water;
dispensing water held in a first one of the container portions at a first point in time to irrigate the root system; and
dispensing water held in a second one of the container portions at a second point in time that is spaced apart from the first point in time to irrigate the root system.

15. The method of claim 14, wherein the container is positioned about the trunk or central stem of a plant.

16. The method of claim 14, wherein the container includes a lid that is positioned above the container portions and wherein the container portions are filled with the lid positioned above the container portions.

17. The method of claim 16, wherein the lid includes a single opening for dispensing water into the container portions.

18. The method of claim 14, further comprising introducing a nutrient supplement into at least one of the container portions prior to dispensing water held in the at least one of the container portions.

19. The method of claim 18, wherein the nutrient supplement is a liquid or soluble solid fertilizer.

20. A method for irrigating a root system comprising:
1) placing a container that is segregated into a plurality of container portions in a location proximate a root system;
2) locating a portable water source proximate the container;
3) filling the container with a hose assembly that is connected to the portable water source such that each of the container portions has a predetermined quantity of water;
4) dispensing water held in a first one of the container portions at a first point in time to irrigate the root system;
5) dispensing water held in a next one of the container portions at a next point in time to irrigate the root system, the next point in time being spaced apart from a preceding point in time at which the root system was last irrigated; and
6) repeating the previous step until each of the container portions is empty and thereafter repeating steps (2) and (3).
